(19) United States
(12) Patent Application Publication
(10) Pub. No.: US 2011/0216871 A1
(43) Pub. Date: Sep. 8, 2011

(54) Channel-Lifting Tool and Method

(76) Inventors: David Francis Wazybok, Castle Hayne, NC (US); David Grey Smith, Leland, NC (US); Edward G. Apple, Wilmington, NC (US)

(21) Appl. No.: 11/955,701

(22) Filed: Dec. 13, 2007

(51) Int. Cl. G21C 19/10

(52) U.S. Cl. 376/261

(57) ABSTRACT

A lifting tool is used for lifting a channel on and off of a nuclear fuel bundle. The lifting tool includes a lifting bail and a leg assembly secured to the lifting bail. The leg assembly has an adjustable width, adjustable between a narrower pre-lifting position and a wider lifting position. The lifting legs are engageable with the channel clips in the lifting position.

### BACKGROUND OF THE INVENTION

The invention relates to tools for use in connection with a nuclear fuel assembly and, more particularly, to a channel-lifting tool for lifting a channel on and off of a nuclear fuel bundle.

A typical nuclear fuel assembly in a boiling light water nuclear reactor includes a lower tie plate, an upper tie plate and a matrix of sealed fuel rods of various length and water rods held in place by spacers supported between the upper and lower tie plates. The fuel rods contain nuclear fuel pellets in sealed containment for supporting a required critical reaction for the generation of steam. A channel is used to surround the upper and lower tie plates, spacers, water rods and fuel rods that make up the nuclear fuel assembly.

Setting the channel is one of the final steps in the assembly of the fuel bundle. The channel setting process involves positioning the channel directly over the fuel bundle and either lowering the channel onto the fuel bundle or by raising the fuel bundle into the channel.

Currently, in order to manipulate the channel, a square stainless steel bar, rounded on it ends, is used with an attached I-bolt that fits between the corners under the channel clips, which are typically located only on two of the four corners of the channel, on opposite sides. The functionality of this tool is sufficient until it encounters the handle located on the upper tie plate near the end of the channel setting process. At this point, the channel must be lifted and/or held up manually by one or two people while the lift bar is removed. This manual lifting or holding the channel up off the lower and upper tie plates is a particular problem with the existing tool. If the channel slips while the tool is being disengaged, an operator's finger can be crushed or severed. Additionally, there are potential quality concerns with manual lifting or holding the channel, including, for example, scratching and/or marking the channel surfaces, distortion of the channel, damaging the finger spring attached to the lower tie plate, damaging the channel clips on the channel if lowered too fast and with too hard of a force onto the upper tie plate, etc.

It would thus be desirable to provide a channel-lifting tool device that is capable of lifting channels from a storage location and securing the channel while being placed on the fuel bundle prior to assembly as a nuclear fuel assembly. It would also be desirable for the tool to facilitate channelling and the removal of a channel from a nuclear fuel assembly without doing damage to the fuel assembly components.

### BRIEF DESCRIPTION OF THE INVENTION

In an exemplary embodiment, a lifting tool is used for lifting a channel on and off of a nuclear fuel bundle. The lifting tool includes a lifting bail and a leg assembly secured to the lifting bail. The leg assembly is selectively displaceable between a pre-lifting position and a lifting position, where the leg assembly is lockable in the lifting position. In the pre-lifting position, the leg assembly is insertable within the channel, and in the lifting position, the leg assembly is engageable with channel clips of the channel.

In another exemplary embodiment, a method of lifting a channel on and off of a nuclear fuel bundle includes the steps of (a) manipulating the lifting tool into the pre-lifting position; (b) inserting the lifting tool into the channel; (c) expanding the lifting tool into the lifting position such that the lifting tool engages the channel clips; and (d) lifting the channel with the lifting tool.

In still another exemplary embodiment, the lifting tool includes a lifting bail, and a pair of lifting legs secured to the lifting bail. The lifting legs have an adjustable width, adjustable between a narrower pre-lifting position and a wider lifting position. The lifting legs are engageable with the channel clips in the lifting position.

### BRIEF DESCRIPTION OF THE DRAWINGS

FIG. 1 illustrates a first embodiment of the lifting tool in its locked, lifting position;

FIG. 2 is a plan view of the lifting tool positioned as shown in FIG. 1;

FIG. 3 shows the lifting tool in its pre-lifting, un-locked position;

FIG. 4 is a plan view of the lifting tool shown in FIG. 3;

FIG. 5 is an end view of the lifting tool showing details of the locking mechanism;

FIG. 6 illustrates a lifting tool of an alternative embodiment in its lifting locked position;

FIG. 7 is a plan view of the lifting tool positioned as shown in FIG. 6;

FIG. 8 shows the lifting tool of FIG. 6 in its pre-lifting unlocked position;

FIG. 9 is a plan view of the lifting tool positioned as shown in FIG. 8;

FIG. 10 is a close-up view of the locking mechanism in the alternative embodiment in the lifting locked position; and

FIG. 11 illustrates a conventional nuclear fuel assembly and the many various components that make up the assembly.

### DETAILED DESCRIPTION OF THE INVENTION

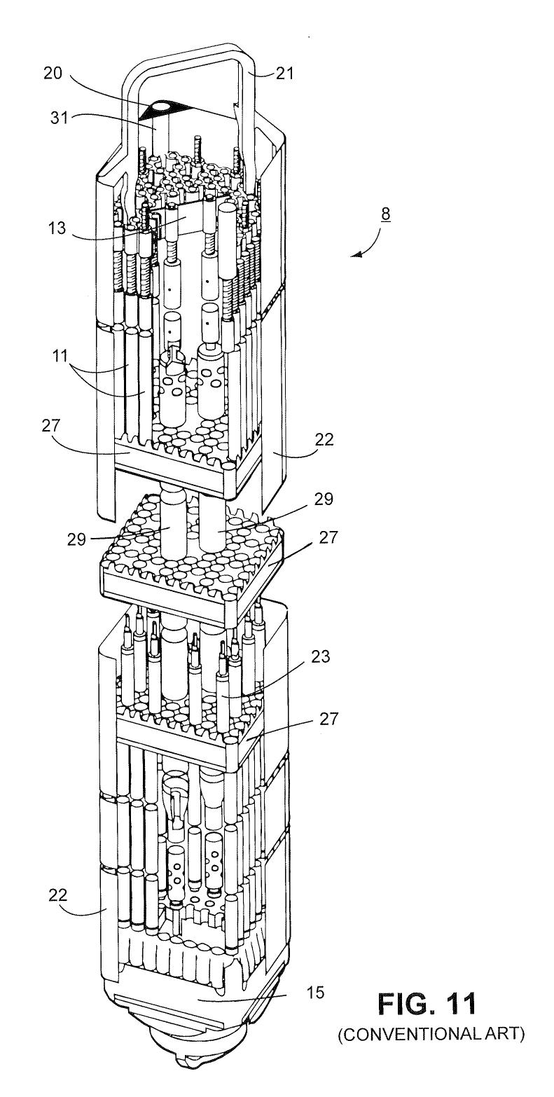

FIG. 11 illustrates a typical boiling light water reactor nuclear fuel assembly and the many various components that go into making the assembly. A typical nuclear fuel assembly in a boiling light water nuclear reactor includes a lower tie plate 15, an upper tie plate 13 and a matrix of sealed nuclear fuel rods, both full length 11 and part-length 23, that are held in place by spacers 27 that help to retain a pair of central located water rods 29 supported between the upper and lower tie plates 13, 15. A square hollow channel 22 is used to surround the upper and lower tie plates 13, 15, spacers 27, water rods 29 and fuel rods 11, 23 that make up the nuclear fuel assembly 8. The upper tie plate has a bail handle 21 that is used to move the nuclear fuel assembly within the reactor core. Each of the square hollow channels 22 is fitted with a single pair of channel clips that are located on opposite corners of the channel 22. One of the two channel clips 20 is designed to have a single hole that allows a channel fastener to retain the channel 22 to the fuel bundle by a threaded post 31 located on one opposite corner of the upper tie plate 13.

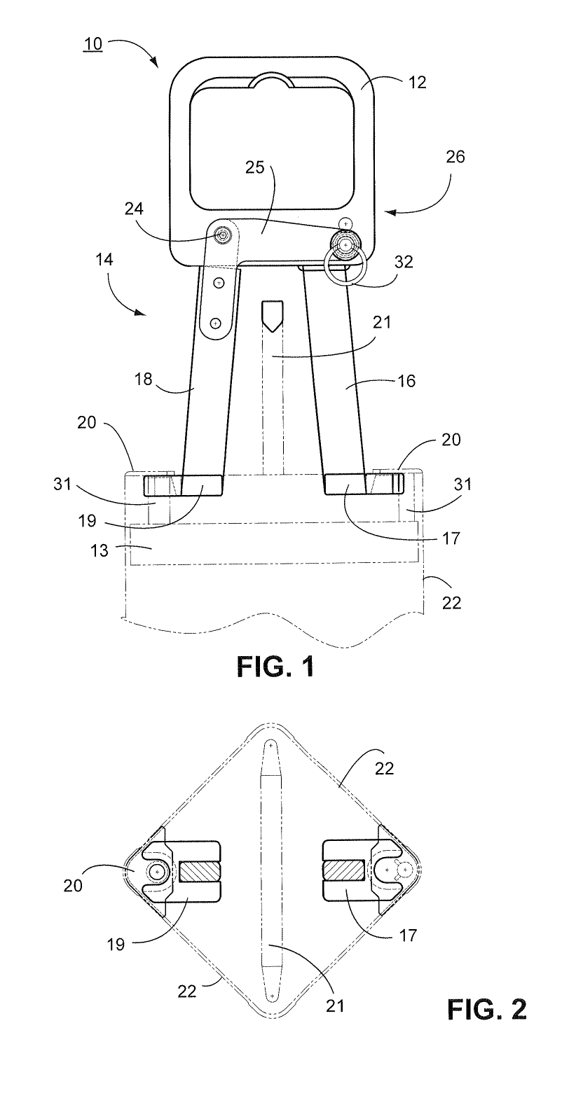

FIGS. 1-5 illustrate a first embodiment of a channel-lifting tool 10 for lifting a channel on and off of a nuclear fuel bundle. The channel-lifting tool 10 includes a lifting bail 12, and a leg assembly 14 secured to the lifting bail 12. In this embodiment, the leg assembly 14 includes a stationary leg 16 including a lifting foot 17 at an end thereof and a movable leg 18 including a lifting foot 19 at an end thereof. The lifting feet 17, 19 are selectively engageable with channel clips 20 of a fuel bundle channel 22 and are preferably machined to be fork-like to fit around the upper tie plate 13 threaded support post 31. The lifting feet 17, 19 may also be forged and/or cast as shown in FIGS. 2 and 4 to more securely engage the channel clips 20 on the top of the channel 22. The lifting feet 17, 19 are designed so as to fit under the channel clips 20 to the inside corner areas of the channel 22. The cutouts (forks) in the lifting feet of the channel-lifting tool 10 allow the tooling to surround three sides of the upper tie plate supporting post 31 located on the upper tie plate 13 and used to secure the channel 22 to the fuel assembly 8.

The movable leg 18 is pivotable relative to the stationary leg 16 via a pivot 24. A locking leg 25 is disposed substantially perpendicular to the movable leg and is fixed to the movable leg 18. An end of the locking leg 25 opposite from the pivot 24 is lockable to a leg locking section of the lifting bail 12 via a locking mechanism 26.

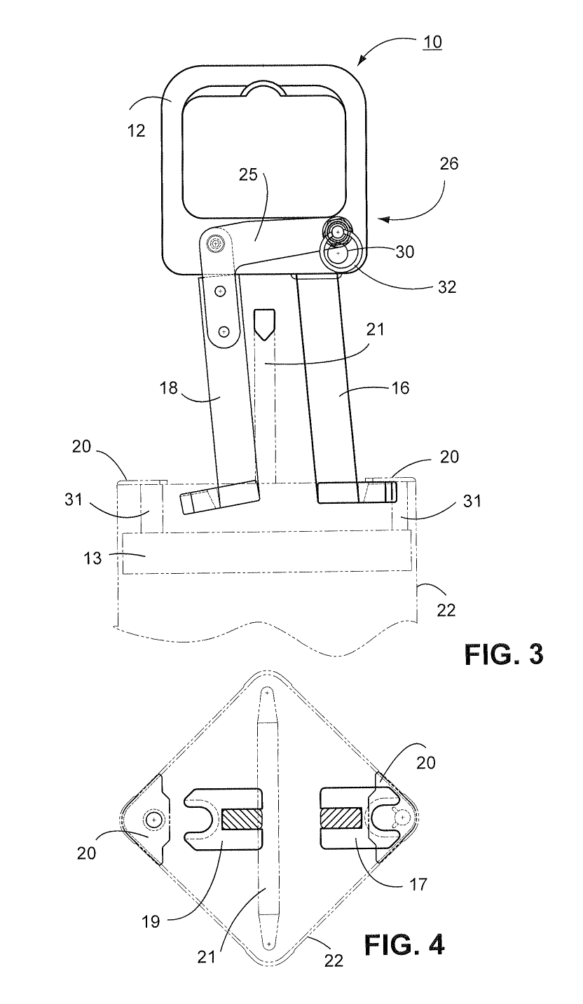

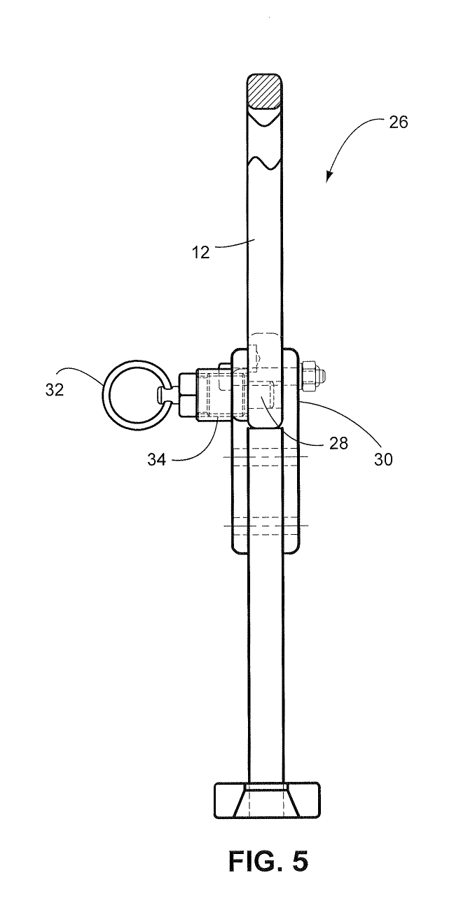

Details of the locking mechanism 26 are shown in FIG. 5. Although any locking mechanism may be used as would be appreciated by those of ordinary skill in the art, in a preferred arrangement, the locking mechanism 26 includes a spring biased locking pin 28, which is biased toward engagement with a pin aperture 30 in the leg locking section of the lifting bail 12. In the locked position, the spring biased locking pin 28 preferably extends substantially the entire way through the lifting bail 12, and an opening through the lifting bail 12 provides a visual acknowledgement that the locking pin 28 is in the locked position when substantially flush to the opposite side of the channel-lifting tool 10. In order to release the spring biased locking pin 28, a ring 32 or other suitable structure enables an operator to pull the spring biased locking pin 28 against a force of a biasing spring 34. Once released, the movable leg 18 is pivotable relative to the lifting bail 12 and the stationary leg 16. See, for example, FIGS. 3 and 4.

In the pre-lifting position shown in FIGS. 3 and 4, the channel-lifting tool 10 has a narrower width with the movable leg 18 pivoted closer to the stationary leg 16. With the narrower width, the channel-lifting tool 10 is insertable into the channel 22 and under the channel clips 20. Once inserted, the movable leg 18 is pivoted (clockwise in FIGS. 1 and 2) until the locking mechanism 26 engages the pin aperture 30 (FIG. 3) in the lifting bail 12 to lock the movable leg 18 in the lifting position as shown in FIGS. 1 and 2. In this position, the lifting feet 17, 19 have a wider width and engage the channel clips 20 for safe lifting of the channel 22. A crane or the like is securable to a gripping section of the lifting bail 12 as part of the channel-lifting tool 10.

In some arrangements, the channel-lifting tool 10 has be orientated to the channel clip 20 that has a single hole, which is aligned with the movable leg 18 of the channel-lifting tool 10, prior to placing the tool under the two channel clips 20 on the top side of the channel 22. This is preferable because once the channel 22 is lifted into the air and above the fuel bundle, it is difficult to see the channel clip 20 with the hole that must be aligned with the threaded support post 31 on the upper tie plate 13, in order to secure the channel 22 to the fuel bundle using the channel fastener that has a male threaded like end plug that secures the channel to the fuel bundle. Thus, in the pre-lifting position, the leg assembly 14 is insertable within the channel 22, in a pre-aligned ordination position with the leg assembly 14 lockable in the lifting position with the location of the channel clip 20 that has a single hole for receiving the channel fastener.

As shown in FIGS. 1 and 3, a length of the leg assembly 14 is preferably greater than a height of the bail handle 21 on the upper tie plate 13 of the nuclear fuel bundle. As such, the channel-lifting tool 10 can remain in place and support the channel 22 until the channel 22 is fully seated on the fuel bundle without the aid of additional operators.

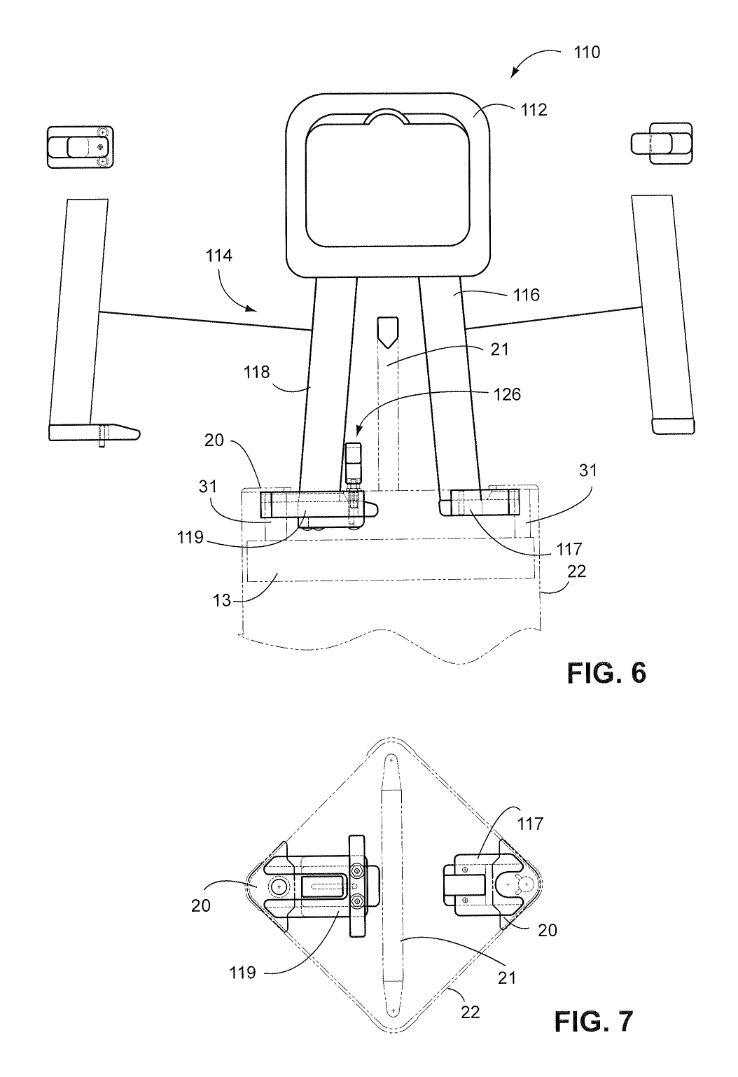

FIGS. 6-10 illustrate an alternative embodiment of the channel-lifting tool. In this embodiment, the channel-lifting tool 110 similarly includes a lifting bail 112 and a leg assembly 114. The leg assembly 114 includes lifting legs 116, 118, both of which in this embodiment are stationary to the lifting bail 112. A lifting foot 117 and a movable lifting foot 119 are similarly provided at distal ends of the lifting legs 116, 118, respectively.

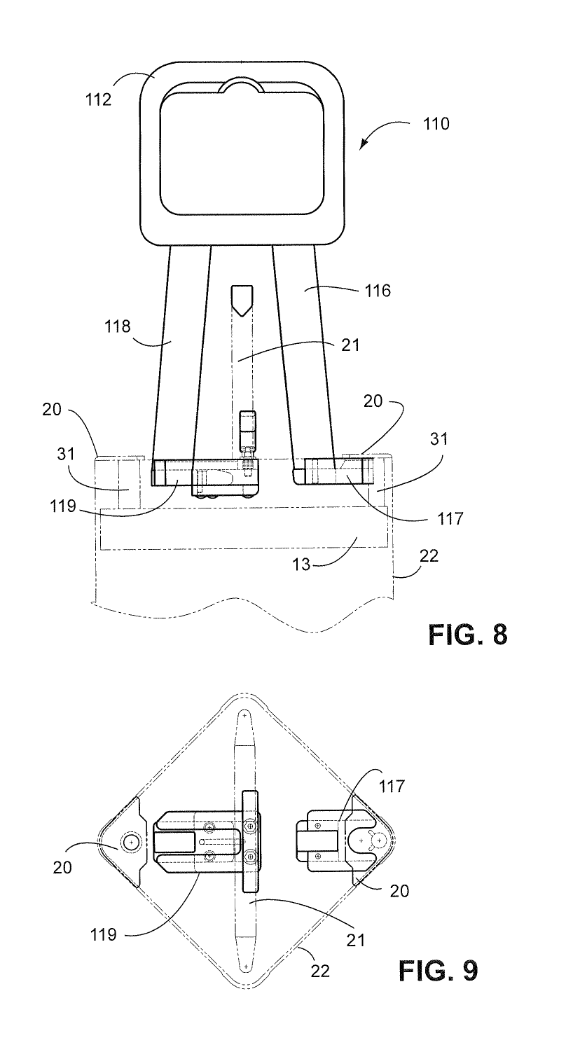

In this embodiment, rather than one of the lifting legs 116, 118 being pivotable relative to the other, a movable lifting foot 119 is displaceable via sliding or the like between a lifting position (FIGS. 6 and 7) and a pre-lifting position (FIGS. 8 and 9).

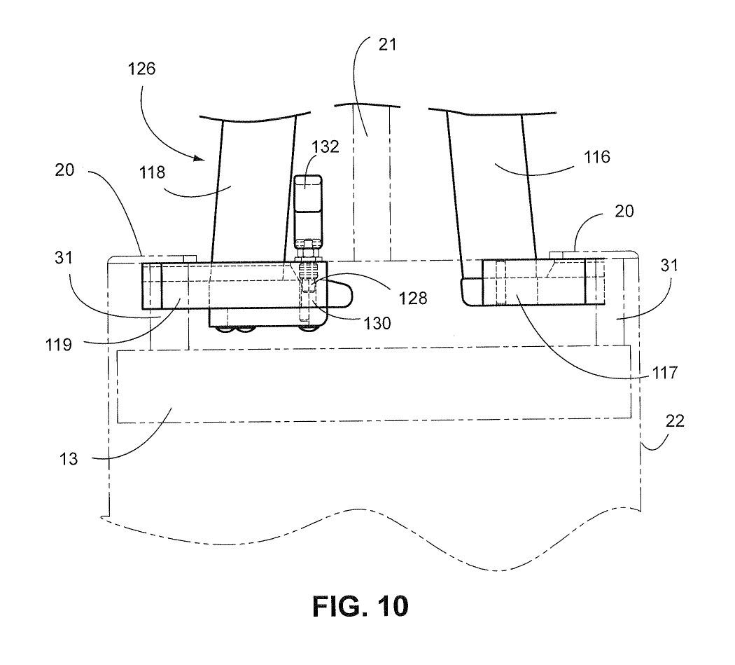

The movable lifting foot 119 is lockable in the lifting position by a locking mechanism 126. With reference to FIG. 10, the locking mechanism 126 includes a spring biased locking pin 128 engageable with an opening 130 in the movable lifting foot 119. A release mechanism 132 is secured to the spring biased locking pin 128 and can be manually pulled to release the spring biased locking pin 128 from the aperture 130 in the movable lifting foot 119. Once released, the movable lifting foot 119 can be slid or otherwise displaced relative to the lifting leg 118. In the pre-lifting position shown in FIGS. 8 and 9, the lifting legs 116, 118 have a width that is narrow enough to be fit within the channel. Once inserted, the movable lifting foot 119 is shifted and locked in the lifting position into engagement with the channel clip 20. Once locked, the lifting tool 110 can be used for lifting a channel onto a fuel bundle and/or off a nuclear fuel assembly 8.

With the structure and methodology of the described channel-lifting tool, the channel setting process in assembling a nuclear fuel assembly is made easier. Additionally, manual lifting of the channel by additional operators is no longer required, thereby improving operator safety. Moreover, scratching and/or marking of the channel surfaces and the possibility of distorting the channel are prevented and eliminated by the use of this tool.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A lifting tool for lifting a channel on and off of a nuclear fuel bundle, the channel including channel clips, the lifting tool comprising:
a lifting bail; and
a leg assembly secured to the lifting bail, the leg assembly being selectively displaceable between a pre-lifting position and a lifting position, and wherein the leg assembly is lockable in the lifting position,
wherein in the pre-lifting position, the leg assembly is insertable within the channel, and wherein in the lifting position, the leg assembly is engageable with the channel clips.

2. A lifting tool according to claim 1, wherein the leg assembly comprises a first movable leg including a first lifting foot attached thereto and a second stationary leg including a second lifting foot attached thereto.

3. A lifting tool according to claim 2, wherein the first movable leg is pivotable relative to the second stationary leg.

4. A lifting tool according to claim 2, wherein the lifting bail comprises a gripping section and a leg locking section, and wherein the leg assembly further comprises a locking leg secured to the first movable leg, the locking leg being selectively lockable to the leg locking section of the lifting bail in the lifting position.

5. A lifting tool according to claim 4, wherein the locking leg is selectively lockable to the leg locking section of the lifting bail by a spring-biased locking pin, the spring-biased locking pin extending substantially entirely through the lifting bail, wherein an opening through the lifting bail provides a visual acknowledgement that the locking pin is in the locked position when substantially flush with an opposite side of the channel-lifting tool.

6. A lifting tool according to claim 4, wherein the first movable leg and the locking leg are pivotally secured to the leg locking section of the lifting bail at a pivot connection.

7. A lifting tool according to claim 4, wherein the locking leg is selectively lockable to the leg locking section of the lifting bail by a spring-biased pin.

8. A lifting tool according to claim 1, wherein the leg assembly comprises first and second legs fixed to the lifting bail, and a movable lifting foot and a stationary lifting foot secured at ends of the first and second legs, respectively, wherein the movable lifting foot is movable relative to the first leg.

9. A lifting tool according to claim 8, wherein the movable lifting foot is lockable to the first leg in the lifting position.

10. A lifting tool according to claim 9, wherein the movable lifting foot is lockable to the first leg by a spring-biased pin.

11. A lifting tool according to claim 1, wherein a length of the leg assembly is greater than a height of a bail handle of the nuclear fuel bundle extending above the channel.

12. A lifting tool according to claim 1, wherein in the pre-lifting position, the leg assembly is insertable within the channel in a pre-aligned ordination position with the leg assembly lockable in the lifting position with the location of one of the channel clips that has a single hole for receiving a channel fastener.

13. A method of lifting a channel on and off of a nuclear fuel bundle with a channel-lifting tool that is positionable in a pre-lifting position and a lifting position, the channel including channel clips, the method comprising:
(a) manipulating the lifting tool into the pre-lifting position;
(b) inserting the lifting tool into the channel;
(c) expanding the lifting tool into the lifting position such that the lifting tool engages the channel clips; and
(d) lifting the channel with the lifting tool.

14. A method according to claim 13, wherein the lifting tool comprises a lifting bail and a pair of legs secured to the lifting bail, and wherein step (a) is practiced by pivoting one of the pair of legs inward relative to the other of the pair of legs.

15. A method according to claim 14, further comprising, prior to step (d), locking the one of the pair of legs in the lifting position.

16. A method according to claim 13, wherein the lifting tool comprises a lifting bail, a pair of legs secured to the lifting bail, and a lifting foot secured to each of the legs, and wherein step (a) is practiced by moving one of the lifting feet relative to the leg to which the foot is secured.

17. A method according to claim 16, further comprising, prior to step (d), locking the one of the pair of lifting feet in the lifting position.

18. A method according to claim 13, further comprising, prior to step (d), locking the lifting tool in the lifting position.

19. A method according to claim 13, wherein step (b) is practiced by inserting the lifting tool into the channel in a pre-ordination position, according to positions of the lockable leg and the channel clip with a single hole to one another for receiving a channel fastener.

20. A lifting tool for lifting a channel on and off of a nuclear fuel bundle, the channel including channel clips, the lifting tool comprising:
a lifting bail; and
a pair of lifting legs secured to the lifting bail, the lifting legs having an adjustable width, adjustable between a narrower pre-lifting position and a wider lifting position, wherein the lifting legs are engageable with the channel clips in the lifting position.

21. A lifting tool according to claim 20, wherein one of the pair of lifting legs is pivotable relative to the other.

22. A lifting tool according to claim 20, wherein each of the lifting legs comprises a lifting foot selectively engageable with the channel clips, wherein one of the lifting feet is displaceable relative to the lifting leg to which it is attached.

23. A lifting tool according to claim 20, wherein the adjustable width of the lifting legs is lockable in the lifting position.

24. A lifting tool according to claim 20, wherein each of the lifting legs comprises a lifting foot respectively engageable with the channel clips, wherein the lifting legs are positioned into a pre-ordination position in relation to a channel clip having a single hole for receiving a channel fastener.
